(19) United States
(12) Patent Application Publication
(10) Pub. No.: US 2014/0372564 A1
(43) Pub. Date: Dec. 18, 2014

(54) Systems and Methods of Content Streaming Using Notifications

(71) Applicant: Cox Communications, Inc., Atlanta, GA (US)

(72) Inventors: Yousef Wasef Nijim, Roswell, GA (US); Jay Paul Langa, Cumming, GA (US); James Alan Strothmann, Johns Creek, GA (US)

(21) Appl. No.: 13/917,934

(22) Filed: Jun. 14, 2013

(51) Int. Cl. H04L 29/06

(52) U.S. Cl. CPC H04L 65/60
USPC 709/219

(57) ABSTRACT

The present disclosure relates to a content streaming system that allows users to customize events that are streamed to client devices. The customization may include timer controls, volume controls, and source controls, the source controls allowing customization of the granularity of the content streamed, and the output medium of the content.

### TECHNICAL FIELD

The present disclosure is generally related to streaming content and, more particularly, is related to streaming and customizing content via notifications.

### BACKGROUND

Content scheduling is the activity of setting a suitable time for content to be presented. Content may be accessible from different sources and over different platforms. While electronic systems have become more interoperable, and bandwidth is constantly increasing, there remain unaddressed opportunities to capitalize on the systems and capabilities that our infrastructure provides.

### SUMMARY

Example embodiments of the present disclosure provide systems of streaming content. Briefly described, in architecture, one example embodiment of the system, among others, can be implemented as follows: a client in communication with a server, the client comprising client software, the client software creating an event comprising content, volume control, and timer control, the timer control determining when the event executes and when the content is streamed to the client.

Embodiments of the present disclosure can also be viewed as providing methods for streaming content. In this regard, one embodiment of such a method, among others, can be broadly summarized by: configuring an event on a client, the event comprising content, timer control, and source control, the timer control determining when the event executes and sends the content streams to the client.

### BRIEF DESCRIPTION OF THE DRAWINGS

FIG. 1 is a schematic view of a system for streaming content via notifications, according to an example embodiment.

FIG. 2 is an example method of utilizing the system of FIG. 1.

FIG. 3 is an example method of one of the steps in the method of FIG. 2.

FIG. 4 is a block diagram of an example embodiment of system for streaming content via notification.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of the systems and methods of content streaming using notifications disclosed herein will allow users to integrate streaming of a video application into other applications that will allow the video application stream, for example, certain channels or programs depending on the policies set by third party applications or within the same application.

Example embodiments of the systems and methods of content streaming using notifications disclosed herein include controlling the video experience on devices such as Smart TVs, gaming consoles, and mobile devices, as non-limiting examples, from other applications within the same video application or integrating the video application with other existing applications on the devices.

For example, if a video application includes an alarm clock function or an alarm clock application includes a video application, a user may set the time she wants to wake up and specify the channel or program that will air at the particular time. Additionally, if the user wants to use the alarm clock function but specify which channel or program to air at the wake up time, then the video application will mute the alarm clock and start streaming video with controlled audio, for example, as specified by the customer. A user may specify the volume, the program, the channel, whether the program is linear, VOD, DVR, third party video application, etc. that streams from the video application. The client application may be integrated with third party applications such as a calendar or messenger application

A user may also set an alarm clock on her mobile device, but the video streaming may be set to occur on a TV in a secondary room, such as the kids' room, or on the gaming console in the living room, as non-limiting examples. In an example embodiment, the same video application exists on several devices within a house, and the user may control on which device they want to stream a program or channel at a certain time. In an example embodiment, if parental control is set on one of these devices, and the alarm is specified to present a channel that is parentally blocked, then the application will notify the customer when setting the device that the program is parentally blocked at that time either for all users or for a particular user. If the customer chooses to keep the parentally blocked program, the alarm may sound. In an example embodiment, when a parentally blocked channel is accessed, it is displayed as a black screen with a parentally block message displayed. When the user is setting the policies for the device (e.g. alarm clock), then the application may communicate back to the application server and the back office where the devices and the rules and policies are set for each device in order to message the user of what is available and what is not on that device.

In an example embodiment, a user may set the alarm for audio only along with adjusting the audio volume on the device depending on the set time and the buzzing time set by the user. A user may set a wake up time and control how many channels or programs on different channels could air for a certain period of time. For example, a user may want to listen to soft music when waking up, and after 5 minutes switch to a news channel, then after 20 minutes, switch to a weather channel. In an example embodiment, a user interface element enables the user to enter the settings of the streamed video based on the settings of the alarm clock.

In an example embodiment, a user may set a sleep time for a streaming program, turn on a device, and stream video at a certain time during the day without allowing the user to tune away from a particular program as non-limiting examples of scheduling functionality. A user may keep looping to the beginning of the same program if it is available on the same channel or on other channels, VOD, YouTube, etc.

After configuring the event, shared friends may be notified of the event when applicable. If notification of shared friends does not apply, then the alarm clock may be set. Notification of shared friends involves acceptance of the friends in a linked application.

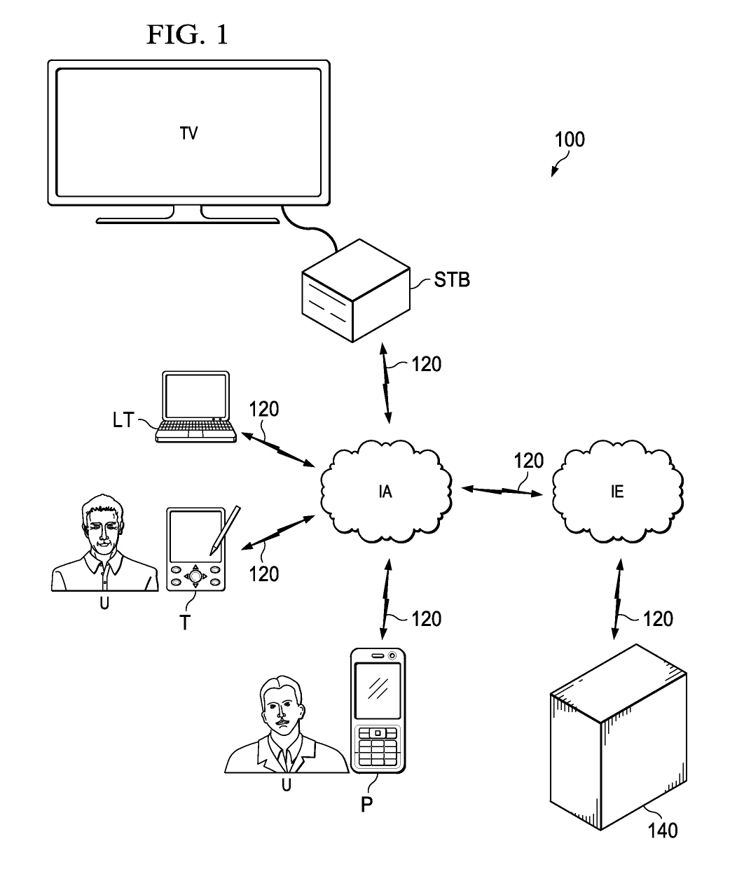

Turning now to FIG. 1, an example embodiment of content streaming system 100 enables communications 120 using at least one of an event, an application, content, and client software. Server 140 comprises server software. Non-limiting examples of the event include volume control, timer control, source control, quality control, content control, and accessibility control, wherein source control may comprise query and results. In the example embodiment shown in FIG. 1, client software runs on phone P, tablet T, laptop LT, and set-top box STB, which is connected to television TV, and events are streamed to client software. Client devices D may comprise at least one of phone P, tablet T, laptop LT, set-top box STB, and television TV. Client devices D may connect to server via intranet IA or to a server in the server provider backoffice or centralized location, for example, if client devices D are on the same network as server 140. Client devices D may communicate within their local network by Wi-Fi, cellular, Bluetooth, etc. Alternatively, client devices D may connect to the server via internet IE to intranet IA or the backoffice server if client devices D are on a different network. Content scheduling may determine when content will be presented for viewing and when access should be automatically discontinued. A user may set specific scheduling parameters for content. A user may set the content on a particular channel to be presented at a specific time. An electronic program guide (EPG) may show program data including titles, show time, etc. to the user. If the content is continually available such as through Video On Demand (VOD), digital video recorder (DVR), network DVR, and Internet content as non-limiting examples, then only the title of the show may be presented as long as the content is available during the configuration of the clock settings and if the content is available during the time set during the configuration.

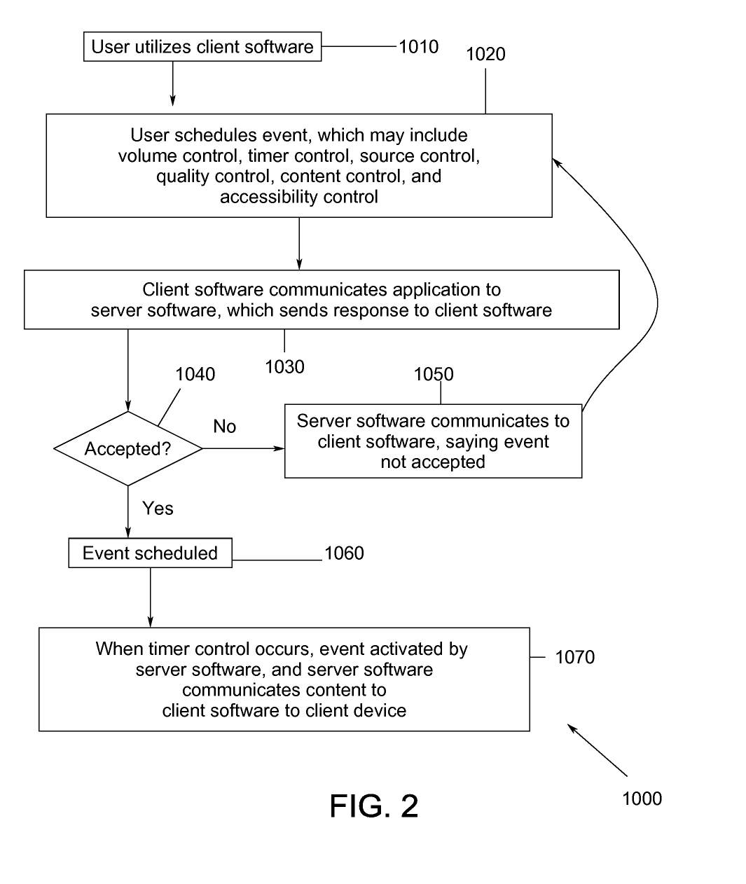

Turning now to FIG. 2, shown therein is an example method of utilizing content streaming system 1000. In block 1010, user U utilizes the client software. In block 1020, user U schedules an event, which may include, as non-limiting examples, volume control, timer control, and source control, wherein source control may include query and results. In block 1030, the client software sends communication 120 to the server software, which accepts or rejects the event in block 1040. Communication 120 happens over intranet IA or through a server in the server provider backoffice or centralized location, for example, if client devices D are on the same network as server 140. The server could reside in the back office, be centralized, or reside in the cloud. Client devices D may communicate within their local network by Wi-Fi, cellular, Bluetooth, etc. Alternatively, client devices D may connect to the server via internet IE to intranet IA or the backoffice server if client devices D are on a different network. If the event is rejected, in block 1050, the server software sends communication 120 to the client software indicating the event as rejected, and method of utilizing content streaming system 1000 proceeds back to block 1020. In block 1060, the event is scheduled, and subsequently, in block 1070, when the timer control occurs, the event is activated by the server software, and the server software sends communication 120 of content to the client software on device D.

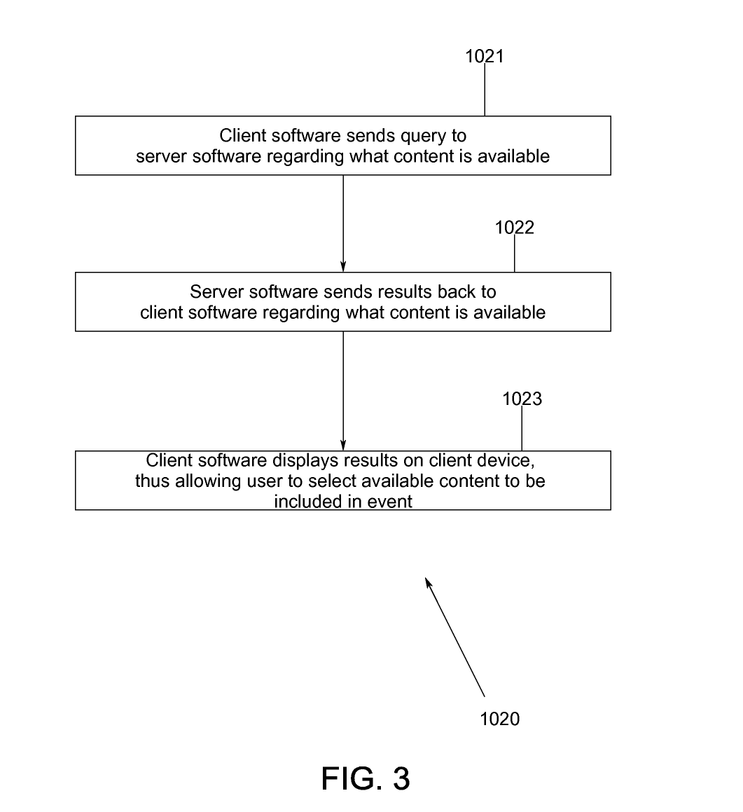

Turning now to FIG. 3, user U scheduling an event comprises step 1020 of FIG. 2 comprises block 1021, wherein the client software sends a query to the server software regarding content that may be available. In block 1022, the server software sends results back to the client software regarding the content that may be available. Subsequently, in block 1023, the client software displays the results on client device D, thus allowing user U to select available content to be included in the event.

For example purposes only, and without limitation, user U utilizes client software on device D, such as laptop LT, to configure an event. The event may comprise set-top box STB sending/receiving content from the server software, wherein the content is sent to television TV at a certain time controlled by the timer control. For example, an event may comprise television TV showing content 160 at 6:30 A.M. Through the volume control, the content may be at a low volume for the first five minutes, followed by an increased volume for another five minutes. Then, the content may transfer from one source to another, e.g., from showing The Weather Channel™ to showing NBC™, or from showing CNN™ to showing content saved on a (DVR) device or VOD. Alternatively, the content may comprise sound from an audio source, such as a radio station, for ten minutes, wherein the content control determines whether the content comprises video, audio, and/or both.

In another example use, an event may direct the content to be directed towards tablet T or phone P. In this scenario, and indeed in every scenario, the content may comprise lower resolution video, wherein the quality control determines how detailed the content is.

In another example use, an event may direct the content to start displaying The Weather Channel™ on television TV for ten minutes, followed by showing CNN™, and five minutes later sending communication 120 to phone P or tablet T once a minute for three minutes.

It is contemplated herein that television TV may comprise client software such as if, for example purposes only and without limitation, television TV is a “Smart TV” running software, such as if the software is the television analogue to what Android or iOS™ are for some smartphones. The Smart TV may comprise a client application configured to display video through IP distribution or QAM distribution, for example.

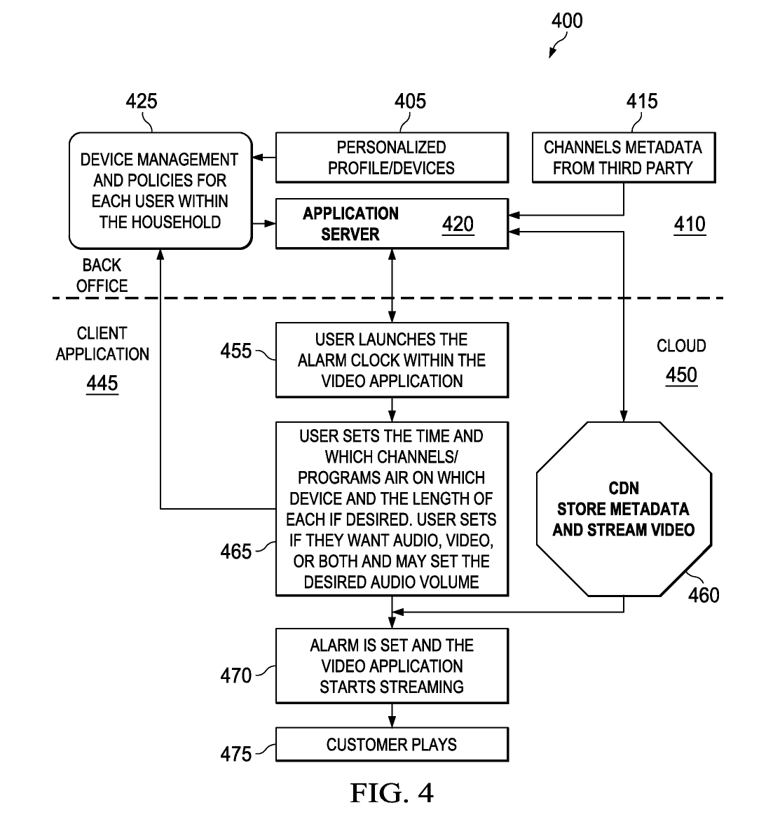

FIG. 4 provides block diagram 400 of an example embodiment of a system of content streaming using notifications with back office 410 and client application 450. In back office 410, content channel metadata 415 is sent from a third party to application server 420. Device management and policies 425 for each user within a particular location (such as a household) are sent to application server 420. The policies may be sent at a low average bit rate because the user is not viewing the content yet. The policies may be set through personalized profile 405 on devices configured for that purpose. In an example embodiment, application server 420 stores metadata and stream video using content delivery network 460 in cloud 450.

In an example embodiment of client application 445, a user may launch alarm clock 455 within a video client application. In the alarm clock a user may set timing function 465 in which the user sets the time and channel/program to be aired on each device registered with client application 445. The user may also designate the length that each channel/program should be presented. Additionally, a user may set the desired audio volume and whether they want to play audio, video, or both. In an example embodiment, the user may select to stream video in a full screen configuration, or in a sealed window. Timing function 465 may update policies and device management 425. After timing function 465 is set, alarm 470 is set and the video application starts streaming the content that may be accessed through content delivery network 460. Content presentation 475 may then be viewed by the user.

The flow charts of FIGS. 2 and 3 show the architecture, functionality, and operation of a possible implementation of the content streaming system. In this regard, each block represents a module, segment, or portion of code, which comprises one or more executable instructions for implementing the specified logical function(s). It should also be noted that in some alternative implementations, the functions noted in the blocks may occur out of the order noted in FIG. 2. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A content streaming system comprising:
a client in communication with a server, the client comprising client software, the client software creating an event comprising content, volume control, and timer control, the timer control determining when the event executes and when the content is streamed to the client.

2. The device of claim 1, wherein the client software is integrated with a third party application.

3. The device of claim 1, the event further comprising source control.

4. The device of claim 3, the source control comprising source quality control and source content control.

5. The device of claim 4, the source quality control determining the granularity of detail of the content.

6. The device of claim 5, the source content control determining whether the content includes audio, video, or both.

7. The device of claim 6, the source control and the timer control determining when the content, which is already streaming to the client, changes.

8. A method of streaming content, the method comprising:
configuring an event on a client, the event comprising content, timer control, and source control, the timer control determining when the event executes and sends the content streams to the client.

9. The method of claim 8, the method further comprising the step of:
sending details of the event from the client to a server.

10. The method of claim 9, the method further comprising:
the client receiving a message that communicates whether the event is allowable.

11. The method of claim 10, wherein the source control and the timer control determine what content is streamed to the client.

12. The method of claim 11, further comprising:
the client receiving the content, and determining the start of the streaming by the timer control.

13. The method of claim 12, further comprising notifying shared friends of the event.

14. The method of claim 13, wherein the source control comprises source quality control and source content control, the source quality control determining the granularity of detail of the content.

15. A tangible or non-transitory computer readable medium comprising software which comprises instructions, the instructions comprising:
configuring an event on a client; and
receiving the event from a server by the client, the event comprising content, volume control, and timer control, the timer control determining when the event executes and when the content stream is sent to the client.

16. The tangible or non-transitory computer readable medium of claim 15, the instructions further comprising the steps of:
the client receiving a message that communicates whether the event is allowable.

17. The tangible or non-transitory computer readable medium of claim 16, the source control and the timer control determining what content is streamed to the client.

18. The tangible or non-transitory computer readable medium of claim 17, the instructions further comprising:
receiving the content by the client;
determining the start of the streaming by the timer control; and
changing the content that is streaming to the client at a predetermined time as configured by the timer control.

19. The tangible or non-transitory computer readable medium of claim 18, the source control comprising source quality control and source content control, the source quality control determining the granularity of detail of the content.

20. The tangible or non-transitory computer readable medium of claim 19, the event further comprising accessibility control, which determines what content may be streamed to the client.
